(19) United States
(12) Patent Application Publication
(10) Pub. No.: US 2010/0166246 A1
(43) Pub. Date: Jul. 1, 2010

(54) RECEIVING STRUCTURE FOR SPEAKER

(75) Inventor: XIAN-JUN ZENG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/606,545

(22) Filed: Oct. 27, 2009

(30) Foreign Application Priority Data
Dec. 30, 2008 (CN) 200810306679.1

(51) Int. Cl. H04R 1/02

(52) U.S. Cl. 381/386

(57) ABSTRACT

A receiving structure for a speaker includes a housing, a filter, a speaker a LED and a circuit board, the housing comprises a receiving cavity, the receiving cavity defines an assembling groove at the bottom, the assembling groove defines a slit at the bottom, the filter is assembled in the assembling groove, the speaker is assembled in the receiving cavity, a LED is assembled adjacent to the speaker, the circuit board encloses the speaker and the LED with the housing. Sound from the speaker and light from the LED pass through the slit to the outside.

### BACKGROUND

1. Field of the Invention

The present disclosure generally relates to receiving structures and, more particularly, to a receiving structure for a speaker in an electronic device.

2. Description of Related Art

Electronic devices such as mobile phones and notebooks typically have a receiving structure for receiving a speak therein. A typical receiving structure includes a housing defining a cavity. The cavity includes a plurality of small slits defined at a bottom through which sound from the speaker is emitted. However, the surface color of the receiving structure is usually dull and unattractive. Moreover, contaminants can enter into the slits and attach on the walls of the slits, which make the receiving structure seem dirty and negatively influences the appearance of the electronic device.

Therefore, there is room for improvement within the art.

### BRIEF DESCRIPTION OF THE DRAWINGS

Many aspects of the disclosed the receiving structure can be better understood with reference to the following drawings. These drawings are not necessarily drawn to scale, the emphasis instead being placed upon clearly illustrating the principles of the exemplary the receiving structure. Moreover, in the drawings like reference numerals designate corresponding parts throughout the several views. Wherever possible, the same reference numbers are used throughout the drawings to refer to the same or like elements of an embodiment.

FIG. 1 is exploded view of an exemplary embodiment of a receiving structure for a speaker.

FIG. 2 is an in assemble, isometric view of the receiving structure of FIG. 1.

FIG. 3 is an assembled view from front surface shown in FIG. 2.

### DETAILED DESCRIPTION OF THE EMBODIMENT

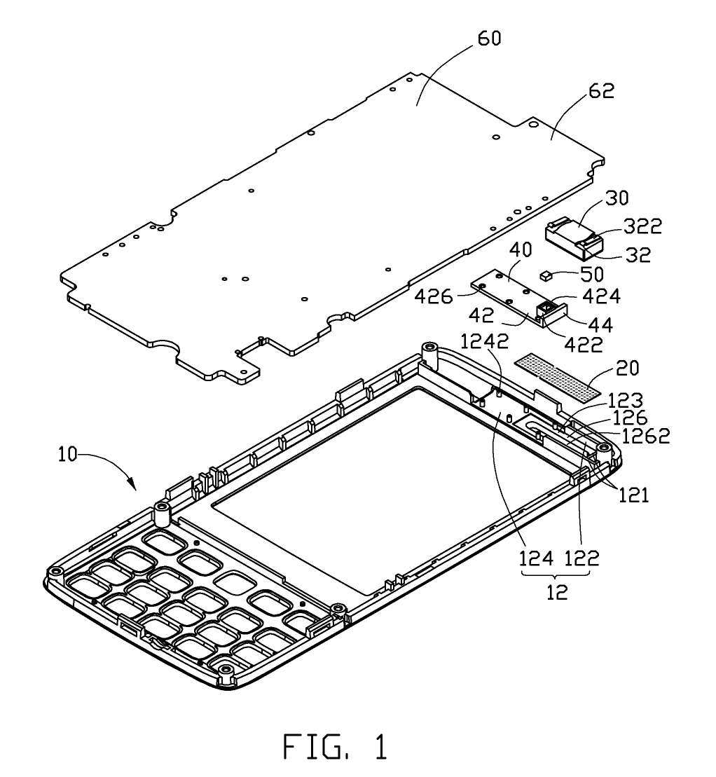

The exemplary embodiment of a receiving structure for a speaker as disclosed is suitable for an electronic device such as a mobile phone, portable computer, and other devices. Referring to FIG. 1, a receiving structure 100 includes a housing 10, a filter 20, a speaker 30, a transparent plate 40, a light emitting diode (LED) 50, and a circuit board 60. The filter 20, the speaker 30 and the transparent plate 40 are assembled between the housing 10 and the circuit board 60, and the LED 50 is positioned on the transparent plate 40 and adjacent to the speaker 30.

The housing 10 defines a receiving cavity 12 in the interior surface. The receiving cavity 12 is located adjacent to a distal end of the housing 10. The receiving cavity 12 receives the filter 20, the speaker 30 and the transparent plate 40. The receiving cavity 12 is surrounded by end walls 121. The end walls 121 enclose a first receiving area 122 of the receiving cavity 12. The first receiving area 122 has an opening 123. The remainder of the receiving cavity 12 is a second receiving area 124. The second receiving area 124 and the first receiving area 122 are separated by the opening 123. The first receiving area 122 receives the speaker 30. The second receiving area 124 corresponds in size to the transparent plate 40 and can receive the transparent plate 40. The bottom of the second receiving area 124 has a plurality of connecting poles 1242 protruding therefrom. The connecting poles 1242 engage with the transparent plate 40. The bottom of the receiving cavity 12 has an assembling groove 126. The assembling groove 126 is located in the second receiving area 124 and the first receiving area 122. The assembling groove 126 corresponds in size to the filter 20 to receive the filter 20. The bottom of the assembling groove 126 defines a slit 1262. The slit 1262 allows sound from the speaker 30 to be transmitted to the outside.

The filter 20 has a plurality of apertures (not labeled). The filter 20 can engage the assembling groove 126 to prevent dust from entering into the slit 1262.

The speaker 30 can be assembled in the first receiving area 122. The speaker 30 includes a connecting surface 32. The connecting surface 32 has two connecting terminals 322 to electronically connect to the circuit board 60.

The transparent plate 40 can be made of glass materials or plastic materials. The transparent plate 40 includes a main board 42 and a flange 44 bent at an end of the main board 42. The main board 42 corresponds to the second receiving area 124 in size and can be assembled in the second receiving area 124. The main board 42 includes an accommodating frame 422 on the upper surface and adjacent to the flange 44. The accommodating frame 422 has an accommodating chamber 424 to receive the LED 50. The transparent plate 40 includes a plurality of connecting holes 426 engaging the connecting poles 1242 of the second receiving area 124.

The LED 50 corresponds with the accommodating chamber 424 in size and can be received in the accommodating chamber 424. The light from the LED 50 can pass through the transparent plate 40 and the slit 1262 to the outside.

The circuit board 60 is engageable with the housing 12 and has an extending portion 62 at the end to cover the first receiving area 122.

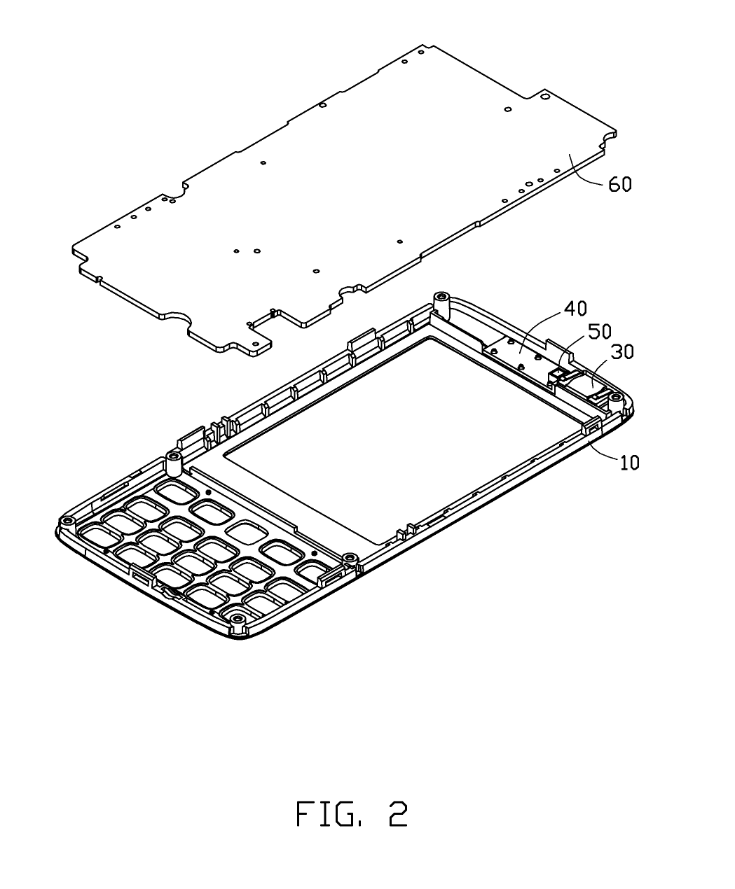

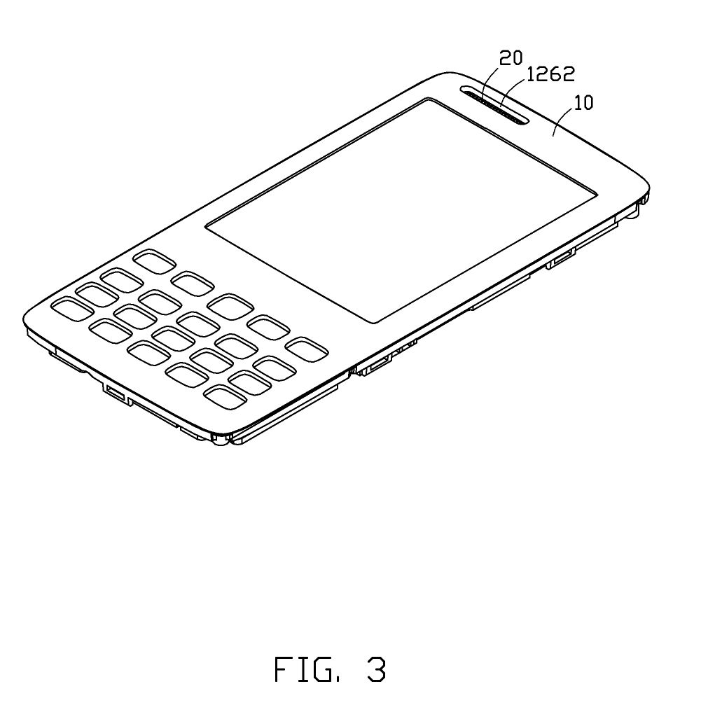

Referring to FIG. 2 and FIG. 3, to assemble the receiving structure 100, the filter 20 is positioned into the assembling groove 126 and covers the slit 1262. The speaker 30 is placed into the first receiving area 122 and abuts the bottom of the assembling groove 126. The LED 50 is attached into the accommodating chamber 424. The transparent plate 40 is secured into the second receiving area 124 with the main board 42 attached to the second receiving area 124. Accordingly, the connecting poles 1242 pass through the connecting holes 426. The connecting poles 1242 can be secured to the main board 42 by hot melting. The flange 44 resists against the end walls 122 and thus seals the opening 123. The circuit board 60 is mounted (for example, screwed) into the housing 10. The extending portion 62 covers the first receiving area 122, and the connecting terminals 322 of the connecting surface 32 electronically connect the circuit board 60.

The speaker 30 is enclosed by the end walls 122, the flange 44 of the transparent plate 40 and the extending portion 62 of the circuit board 60. The speaker 30 can transmit sounds to the outside through the filter 20 and the slit 1262, enhancing sound quality of the speaker 30. Furthermore, the light from the LED 50 can penetrate to the outside through the filter 20 and the slit 1262, which brightens the receiving structure 100.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A receiving structure for a speaker, comprising:
a housing comprising a receiving cavity defining a slit at the bottom thereof;
a speaker assembled in the receiving cavity with the sound from the speaker transmitted through the slit to the outside;
a LED assembled adjacent to the speaker with the light from the LED emitted through the slit to the outside.

2. The receiving structure as claimed in claim 1, wherein the receiving cavity have end walls formed at an end, the end walls encloses a first receiving area, the speaker is received in the first receiving area.

3. The receiving structure as claimed in claim 2, wherein the receiving cavity includes a second receiving area abutting the first receiving area, the receiving structure includes a transparent plate assembled the LED therein, the transparent plate is positioned in the second receiving area.

4. The receiving structure as claimed in claim 1, wherein the slit is located in the first receiving area and the second receiving area.

5. The receiving structure as claimed in claim 3, wherein the first receiving area has an opening, the transparent plate has a flange bent at an end to seal the opening.

6. The receiving structure as claimed in claim 5, wherein the receiving structure includes a circuit board having an extending portion, the extending portion resists the end walls and the flange to cover the first receiving area, the circuit board connects electronically with the speaker.

7. The receiving structure as claimed in claim 5, wherein the bottom of the receiving cavity defines an assembling groove located in the first receiving area and the second receiving area, the receiving structure includes a filter to assemble in the assembling groove.

8. The receiving structure as claimed in claim 7, wherein the slit is defined in the bottom of the assembling groove.

9. The receiving structure as claimed in claim 5, wherein the transparent plate includes a main board defining a plurality of connecting holes therein, the second receiving area forms a plurality of connecting poles to correspondingly engage with the connecting holes.

10. The receiving structure as claimed in claim 9, wherein the flange is bent at an end of the main board, the main board forms an accommodating frame adjacent to the flange, the accommodating frame receives the LED.

11. A receiving structure for a speaker, comprising:
a housing comprising a receiving cavity defining an assembling groove at the bottom thereof, the assembling groove defining a slit at the bottom thereof;
a filter assembled in the assembling groove;
a speaker assembled in the receiving cavity with sound from the speaker transmitted through the slit to the outside;
a LED assembled adjacent to the speaker with the light from the LED emitted through the slit to the outside;
a circuit board enclosed the speaker and the LED with the housing.

12. The receiving structure as claimed in claim 11, wherein the receiving cavity have end walls formed at an end, the end walls encloses a first receiving area, the speaker is received in the first receiving area.

13. The receiving structure as claimed in claim 12, wherein the receiving cavity includes a second receiving area abutting the first receiving area, the receiving structure includes a transparent plate assembled the LED therein, the transparent plate is positioned in the second receiving area.

14. The receiving structure as claimed in claim 11, wherein the slit is defined in the first receiving area and the second receiving area.

15. The receiving structure as claimed in claim 13, wherein the first receiving area has an opening, the transparent plate has a flange bent at an end to seal the opening.

16. The receiving structure as claimed in claim 15, wherein the receiving structure includes a circuit board having an extending portion, the extending portion resists the end wall and the flange to cover the first receiving area, the circuit board connects electronically with the speaker.
